(19) United States
(12) Patent Application Publication
(10) Pub. No.: US 2007/0038468 A1
(43) Pub. Date: Feb. 15, 2007

(54) Method and system for sponsoring sports teams and individual athletes

(76) Inventor: Marc Walker, Ellenwood, GA (US)

Correspondence Address: NEEDLE & ROSENBERG, P.C., SUITE 1000, 999 PEACHTREE STREET, ATLANTA, GA, 30309-3915, US

(21) Appl. No.: 11/442,827

(22) Filed: May 30, 2006

Related U.S. Application Data
(60) Provisional application No. 60/685,558, filed on May 27, 2005.

(51) Int. Cl. G06Q 99/00

(52) U.S. Cl. 705/1

(57) ABSTRACT

A system and method for sponsoring sports teams or individual athletes that enables a plurality of users to use the power of accumulation to sponsor sports teams or individual athletes. Users can contribute an amount of money smaller than what is normally required to sponsor a sports team or athlete and in exchange receives recognition for the contribution. Once the contributions from multiple Users accumulates to an amount large enough to sponsor a sports team or individual athlete, the funds are transferred to the sports team or individual athlete in exchange for recognizing the host as a sponsor.

### CROSS REFERENCE TO RELATED PATENT APPLICATIONS

This application claims priority to U.S. Provisional Application No. 60/685,558 filed May 27, 2005 herein incorporated by reference in its entirety.

### BACKGROUND OF THE INVENTION

In the past, sports fans have not generally been able to participate in a sponsorship role. One of the barriers is the disparity between the financial amount a single fan can contribute and the financial amount that is needed by a sports team or individual athlete to meet their needs. Another barrier between the fans, the sports teams and the individual athletes, is a physical one (i.e. the fence, the wall, the gate, the yellow tape, etc.). Fans typically do not have the physical contacts through which to engage in sponsorship activity. These barriers have an adverse effect on both the fans and the sports teams and individual athletes. The fans have a strong desire to show their support through financial sponsorship. The sports teams and individual athletes require financial sponsorship in order to compete effectively.

The disclosed system and method closes the gap between the fans and the sports teams and individual athletes through the creation of a cumulative sponsorship environment. This system and method brings fans closer to the sports in which they are involved by allowing the fans the opportunity to have a monetary investment in the sport. The system and method enables additional revenue sources for sports teams and individual athletes, allowing them to compete without fear of loss of funding.

### SUMMARY OF THE INVENTION

Disclosed herein is a system and method for sponsoring sports teams or individual athletes that enables a plurality of users to use the power of accumulation to sponsor sports teams or individual athletes. Users can contribute an amount of money smaller than what is normally required to sponsor a sports team or individual athlete to a host and in exchange receives recognition for the contribution from the host. Once the contributions from multiple Users accumulates to an amount large enough to sponsor a sports team or individual athlete, the funds are transferred to the sports team or individual athlete from the host in exchange for recognizing the host as a sponsor.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 is a flow diagram illustrating an exemplary implementation of the disclosed method.

FIG. 2 is a flow diagram illustrating an exemplary system implementing the disclosed method.

FIG. 3 is a more detailed system flow diagram illustrating an exemplary sponsorship transaction.

FIG. 4 is a high-level pictorial illustrating the relationships between the disclosed system and method and other entities.

FIG. 5 is an exemplary computing environment through which the disclosed system and method can be practiced.

FIG. 6 is a flow diagram illustrating an exemplary implementation of the disclosed method.

FIG. 7 is a flow diagram illustrating an exemplary implementation of the disclosed method.

FIG. 8 is a flow diagram illustrating an exemplary implementation of the disclosed method.

### DETAILED DESCRIPTION OF THE INVENTION

The present invention may be understood more readily by reference to the following detailed description of preferred embodiments of the invention and to the Figures and their previous and following description.

Before the present system and method are disclosed and described, it is to be understood that this invention is not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a sponsor” includes mixtures of sponsors, reference to “a sponsor” includes mixtures of two or more such sponsors, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

In this specification and in the claims which follow, reference will be made to a number of terms which shall be defined to have the following meanings:

“Host” is defined as the organizational entity through which the transactions of the present system and method take place. The “host” can also refer to the internet server responsible for conducting said transactions.

“Sports Team” is defined as a group of individuals cooperating to compete in sporting events. Examples include, but are not limited to, the Atlanta Braves®, the Atlanta Falcons®, and the Atlanta Hawks®.

“Individual Athlete” is defined as a person trained to compete in sports. Examples include, but are not limited to, Lance Armstrong and Tiger Woods.

“Sponsorship Transaction” is defined as a user transferring funds to the host and the user receiving a sponsorship award.

“Sponsorship Amount” is defined as a sum of money transferred from a user to the host for the purpose of sponsoring a sports team or individual athlete. Examples include, but are not limited to, five dollars, ten dollars, and one-hundred dollars.

“Cumulative Sponsorship Amount” is defined as an amount determined by the host and sports teams and individual athletes that is a minimum acceptable sponsorship amount. Examples include, but are not limited to, five-hundred dollars, one-thousand dollars, ten-thousand dollars.

“Primary Sponsor” is defined as the sponsor that is the largest most visible sponsor of a sports team or individual athlete. Examples include, but are not limited to, the United States Postal Service was a primary sponsor of Lance Armstrong, a successful cyclist, for many years.

“Co-Sponsor” is defined as a sponsor that is not the largest most visible sponsor of a sports team or individual athlete.

Reference will now be made in detail to the present aspects of the invention, example) of which are illustrated in the accompanying drawings. Wherever possible, the same reference numbers are used throughout the drawings to refer to the same or like parts. The system and method disclosed herein can be applied to various sports and sponsor targets. Examples of such sports include, but are not limited to, surfing, skate boarding, fishing, soccer, snow boarding, water skiing, boating, slalom down hill skiing, sailing, and all motorized and mechanized sports.

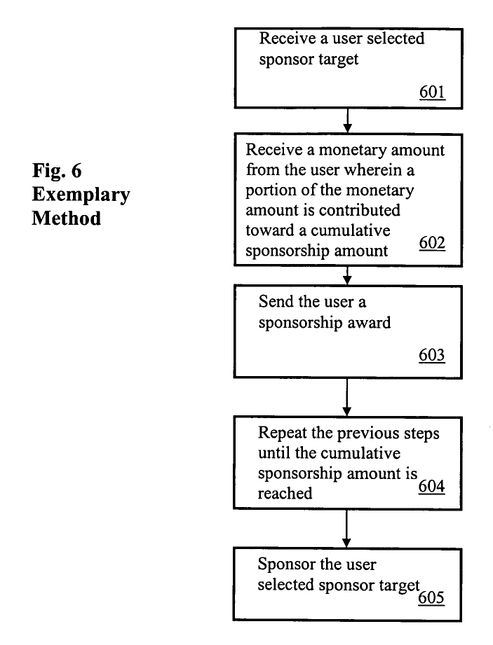

In one aspect, illustrated in FIG. 6, a method for sponsoring is provided that comprises receiving a user selected sponsor target (step 601), receiving a monetary amount from the user wherein a portion of the monetary amount is contributed toward a cumulative sponsorship amount (step 602), sending the user a sponsorship award (step 603), repeating the previous steps until the cumulative sponsorship amount is reached (step 604), and sponsoring the user selected sponsor target (step 605). The user selection can be made over a network. The user selected sponsor target can be, for example, athletes, sports teams, and vehicles. The sponsor target can be, for example, an Olympic team, a Nascar® driver, and an X-Games athlete. The sponsorship award can indicate that the user sponsored the user selected sponsor target. The value of the sponsorship award is associated with the monetary amount received from the user.

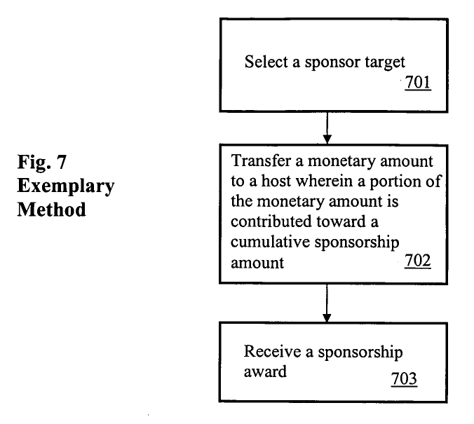

In a further aspect, illustrated in FIG. 7, a method for sponsoring is provided that comprises selecting a sponsor target (step 701) and transferring a monetary amount to a host wherein a portion of the monetary amount is contributed toward a cumulative sponsorship amount (step 702), and receiving a sponsorship award (step 703). The user selection can be made over a network. The user selected sponsor target can be, for example, athletes, sports teams, and vehicles. The sponsor target can be, for example, an Olympic team, a Nascar® driver, and an X-Games athlete. The sponsorship award can indicate that the user sponsored the user selected sponsor target. The value of the sponsorship award is associated with the monetary amount received from the user.

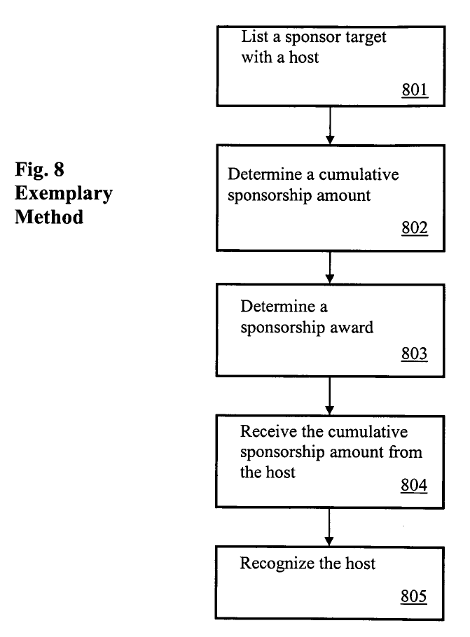

In another aspect, illustrated in FIG. 8, a method of sponsoring is provided that comprises listing a sponsor target with a host (step 801), determining a cumulative sponsorship amount (step 802), determining a sponsorship award (step 803), receiving the cumulative sponsorship amount from the host (step 804), and recognizing the host (step 805). The listing can be performed over a network. The sponsor target can include, for example, athletes, sports teams, and vehicles. The sponsor target can be, for example, an Olympic team, a Nascar® driver, and an X-Games athlete. The sponsorship award can indicate that a user sponsored the sponsor target. The value of the sponsorship award can be associated with a monetary amount received from a user.

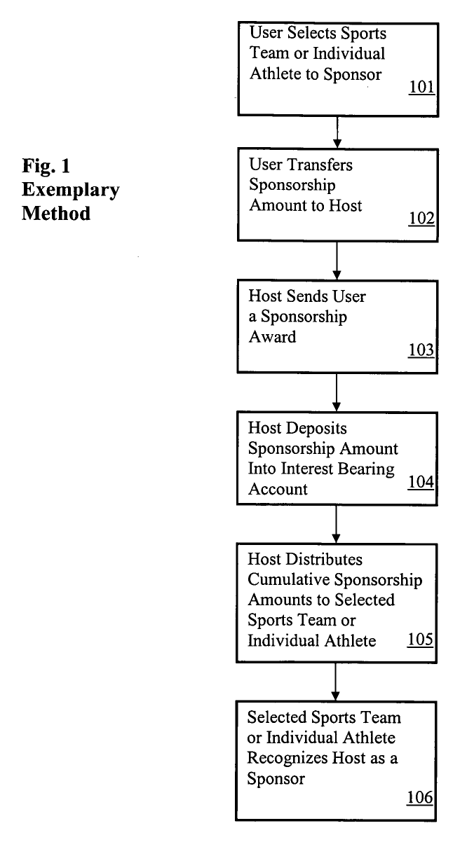

FIG. 1 illustrates generally, the steps involved in the disclosed method for sponsoring sports teams or individuals (both also referred to as sponsor targets). The first step 101 of the method comprises a user selecting a Sports Team 206a,b or an Individual Athlete 207a,b to sponsor. This selection can be through the Internet 208 at a host website, at a retail location, at a sporting event, and the like. Once the user has selected a Sports Team 206a,b or an Individual Athlete 207a,b to sponsor, the user transfers the desired sponsorship amount to the host, as indicated in block 102. The transfer can be through the internet via electronic funds transfer means such as bank accounts, credit cards, Paypal®, or the like. The transfer can also be through a point of sale transaction such as credit cards, checks, or cash. The host sends the user a sponsorship award upon receipt of the sponsorship amount, as indicated in block 103. The award's value can be directly related to the amount of the sponsorship amount. The award can be a pen, a t-shirt, a towel, a cup, a hat, a sticker, a poster, or similar. The host will then proceed to deposit the sponsorship amount into a financial account, as indicated in block 104. The financial account can be an interest bearing account such as, for example, a Cash Deposit (CD), a mutual fund, a checking account, or a savings account. After a sufficient number of users have contributed sponsorship amounts such that a pre-determined cumulative sponsorship amount is reached, the host will distribute the cumulative sponsorship amount to the selected Sports Team 206a,b or an Individual Athlete 207a,b, as indicated in block 105. The cumulative amount can be determined by the Sports Team 206a,b or an Individual Athlete 207a,b. For example, Jeff Gordon, a top NASCAR® driver and team, has a minimum sponsorship amount of approximately $80,000.00. In exchange for this amount, the sponsor receives a 5×12 inch space on both sides of Jeff Gordon's race car for the racing season. The selected Sports Team 206a,b or an Individual Athlete 207a,b will recognize the host as a sponsor, as indicated in block 106. Such recognition can include, but is not limited to, placing a host logo on a Sports Team 206a,b or an Individual Athlete 207a,b vehicle, uniform, equipment, banner at a sporting venue, and the like.

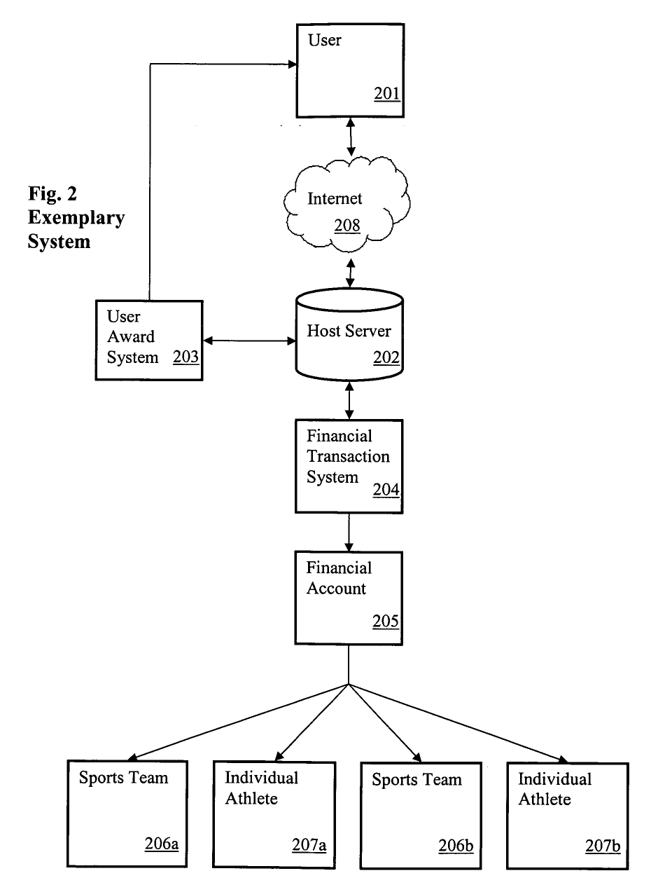

FIG. 2 illustrates generally, an exemplary system implementing the disclosed method. This exemplary system is only an example of a system and is not intended to suggest any limitation as to the scope of use or functionality of system architecture. Neither should the system be interpreted as having any dependency or requirement relating to any one or combination of components illustrated in the exemplary system. FIG. 2 illustrates the primary components and relationships of the disclosed system and method. A User 201 interacts with a host server 202 via the Internet 208 through an internet-enabled computer connection. The User 201 interacts with the host server 202 via an internet enabled personal computer running a standard web-browser. The User 201 can also interact with the host server 202 via standard Point of Sale transactions. An example of such Point of Sale transactions includes conducting a sponsorship transaction at a physical location such as a sporting goods store, a sport specialty store, or a sporting event. The User 201 is also capable of interacting with the host server 202 through a plurality of internet enabled kiosks at various physical locations. The host server 202 is capable of conducting a plurality of sponsorship transactions with a plurality of Users 201. Through the host server 202, the User 201 is able to view a host website and browse and search a plurality of Sports Teams 206a,b or Individual Athletes 207a,b to sponsor. The host server 202 supports a plurality of User 202 profile databases, Sports Team 206a,b and Individual Athlete 207a,b databases, Primary Sponsor and Co-sponsor 406 databases, and credit card and other financial transaction processing. It will be readily apparent to those skilled in the art that the databases can be any suitable database management system such as Oracle, Informix, Sybase, SQL Server, Access, mySQL, PostgreSQL, or the like. Once the User 201 selects a Sports Teams 206a,b or Individual Athlete 207a,b to sponsor, the User 201 can electronically transfer funds to the host through the host server 202 via a Financial Transaction System 204. The Financial Transaction System 204 can implement electronic funds transfers between a multitude of financial accounts as is known to one skilled in the art. The host server 202 can interact with a User Award System 203 to send the User 201 a sponsorship award. The User Award System can vary depending upon the Sports Teams 206a,b or Individual Athlete 207a,b. By way of example, and not limitation, there can be three levels of sponsorship Silver, Gold, and Platinum. The Silver level can be reached by contributing $200.00. The User 201 can receive a hat and t-shirt with the host logo, access to messages from their team keeping them up to date with team happenings, offers for discount tickets and travel to events, and the right to say they sponsored the Sports Teams 206a,b or Individual Athlete 207a,b. Gold level can be reached by contributing $500.00. The User 201 can receive the benefits of the Silver level, plus “behind the scenes” passes, t-shirt and hats with the name of the Sports Teams 206a,b or Individual Athlete 207a,b they are sponsoring. The Platinum level can be reached by contributing $1,000.00. The User 201 can receive the benefits of the Silver and Gold levels, plus a jacket with the Sports Teams 206a,b or Individual Athlete 207a,b, autographed posters, license plates frames, key chains, and “VIP” lunches at selected events hosted by the host. These benefits will vary based on the particular sporting events. The host server 202 electronically transfers the sponsorship amount through the Financial Transaction System 204 into a Financial Account 205. Once a cumulative sponsorship amount has been reached for a sports team or individual, the cumulative sponsorship amount is transferred from the Financial Account 205 to the Sports Team 206a,b or Individual Athlete 207a,b selected by the User 201.

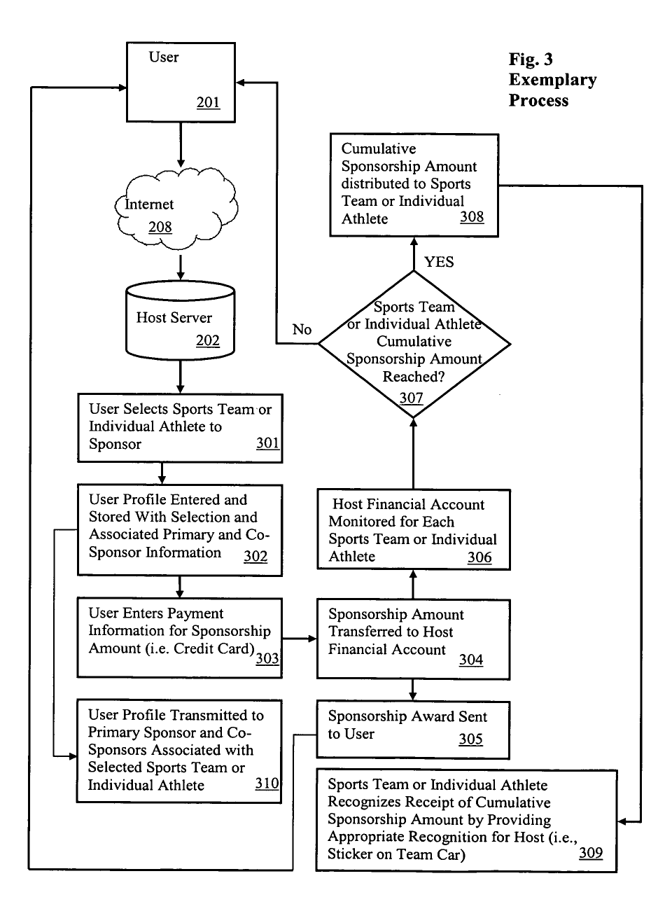

FIG. 3 illustrates a more detailed view of the sponsorship transaction process. The User 201 uses an internet-enabled computer to access the host server 202 via the Internet 208. As indicated in block 301, User 201 browses and searches through the host website and queries various Sports Team 206a,b and Individual Athlete 207a,b databases. The User 201 can view the name of the Sports Team 206a,b and Individual Athlete 207a,b along with the sponsorship award that the User 201 can receive based on a sponsorship amount. The User 201 selects the specific Sports Team 206a,b and/or individual Athlete 207a,b to sponsor and, as indicated in block 302, the User 201 then enters their User 201 profile into a user profile database on the host Server 202. A User 201 profile can contain pertinent information such as, but not limited to, name, address, phone number, email address, and sport preferences. The User 201 will only need to enter this information once, as their information is stored and is accessible by the User 201 via a password. The User 201 profile will be associated with the Primary Sponsor and Co-sponsors 406 associated with the Sports Team 206a,b or Individual Athlete 207a,b that the User 201 selected to sponsor. As shown in block 310, the User 201 profile can be transmitted to the primary sponsor and co-sponsors for various marketing uses. Such marketing uses can include, but are not limited to, direct product marketing to Users 201, providing discounts to Users 201, and the like. As indicated in block 303, after the User 201 has entered their profile information, the User 201 enters payment information to transfer the desired sponsorship amount to the host. Payment information can include, but is not limited to, credit cards, bank account and routing numbers, Paypal® accounts, and the like. The payment is processed and the sponsorship amount is deposited into a host financial account as indicated in block 304. The host financial account can be, for example, a checking account, a savings account, a mutual fund, and the like. A sponsorship award is sent to the User 201, as shown in block 305. The sponsorship award can include pens, t-shirts, towels, posters, tickets to sporting events, and the like. The host financial account is monitored to determine when a pre-determined cumulative sponsorship amount has been reached for each Sports Team 206a,b or Individual Athlete 207a,b, as indicated in block 306. As shown in block 307, if the cumulative sponsorship amount has not been reached, the process continues with the same or other Users 201 until the cumulative sponsorship amount is reached. As shown in block 307, if the cumulative sponsorship amount has been reached, the cumulative sponsorship amount is transferred to the appropriate Sports Team 206a,b or Individual Athlete 207a,b, as shown in block 308. Such distributions can be made, for example, by mailing a check to the Sports Team 206a,b or Individual Athlete 207a,b, automatically electronically depositing funds, and the like. As indicated in block 309, the Sports Team 206a,b or Individual Athlete 207a,b will recognize the receipt of the cumulative sponsorship amount by promoting the host. Such promotion of the host can be made by, for example, placing a host logo on a team vehicle, uniform, banner, website, and the like,

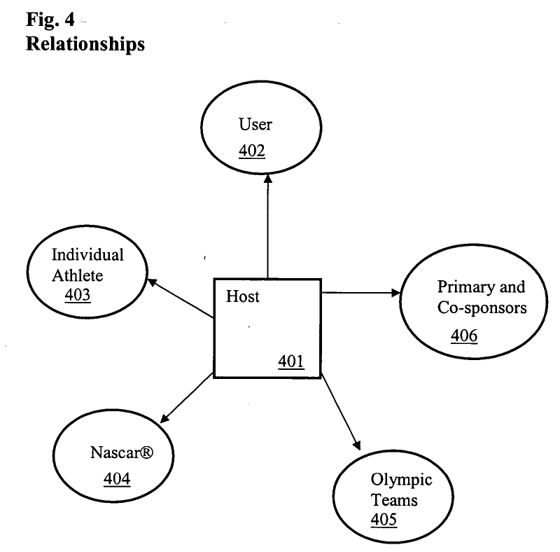

FIG. 4 describes examples of synergies generated by the disclosed system and method. The User 402 benefits through having the ability to sponsor their favorites sports teams and individual athletes. This allows the User 402 to show their support through financial contribution and ensures the success of the sport as a whole. The Individual Athlete 403 benefits through receiving sponsorship funds that might not have been received otherwise, thus ensuring the Individual Athlete 403 can continue to participate in the sport. Nascar® 404 benefits through receiving sponsors for the drivers and their teams, thus connecting the fans to the sport more intimately, ensuring fan loyalty. Olympic Teams 405 benefit through receiving much needed funding to cover training and travel costs, allowing the teams to concentrate on their sport. Primary and Co-sponsors benefit by receiving invaluable marketing information. This information can allow targeted advertising and product offering. These benefits are conveyed by and through the host 401, serving as the medium through which all the aforementioned benefits flow.

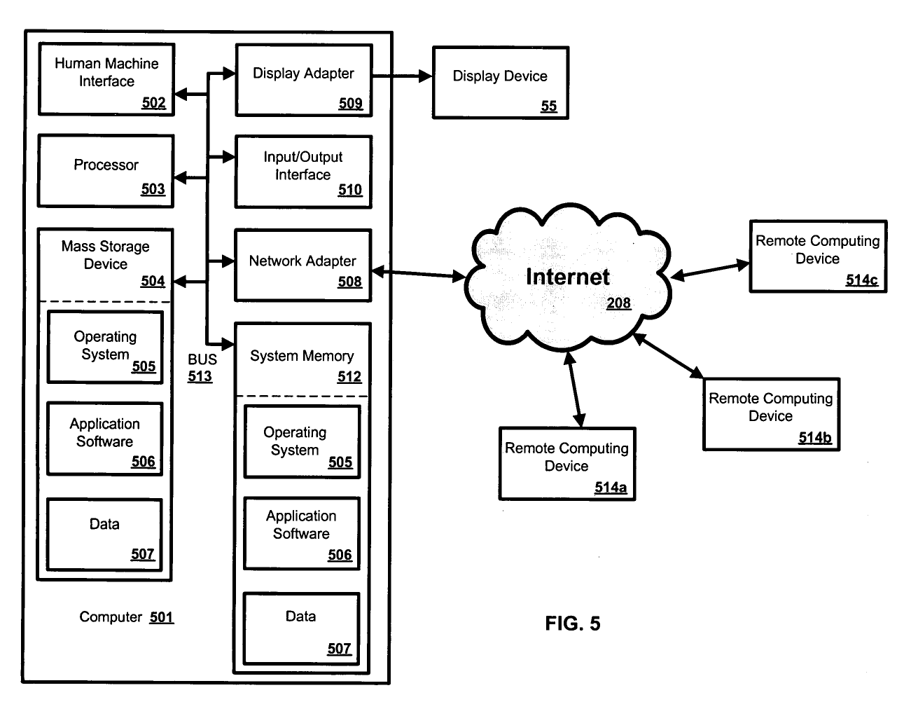

FIG. 5 illustrates an example of a suitable computing system environment in which the system and method may be implemented. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment. In particular, the environment is an example of computerized devices that can implement the system and method as has been described.

The system and method are operational with numerous other general purpose or special purpose computing system environments or configurations. Examples of well known computing systems, environments, and/or configurations that may be suitable for use with the system and method include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The system and method may be described in the general context of computer instructions, such as program modules, being executed by a computer. Generally, program modules include routines, programs, objects, components, data structures, etc. that perform particular tasks or implement particular abstract data types. The system and method may also be practiced in distributed computing environments where tasks are performed by remote processing devices that are linked through a communications network. In a distributed computing environment, program modules may be located in both local and remote computer storage media including memory storage devices.

The systems of FIGS. 2, and 3, can include a general-purpose computing device in the form of a computer 501. The components of the computer 501 can include, but are not limited to, one or more processors or processing units 503, a system memory 512, and a system bus 513 that couples various system components including the processor 503 to the system memory 512.

The system bus 513 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 513, and all buses specified in this description can also be implemented over a wired or wireless network connection and each of the subsystems, including the processor 503, a mass storage device 504, an operating system 505, application software 506, data 507, a network adapter 508, system memory 512, an Input/Output Interface 510, a display adapter 509, a display device 511, and a human machine interface 502, can be contained within one or more remote computing devices 515a,b,c at physically separate locations, connected through buses of this form, in effect implementing a fully distributed system.

The computer 501 typically includes a variety of computer readable media. Such media can be any available media that is accessible by the computer 501 and includes both volatile and non-volatile media, removable and non-removable media.

The system memory 512 includes computer readable media in the form of volatile memory, such as random access memory (RAM), and/or non-volatile memory, such as read only memory (ROM). The system memory 512 typically contains data such as data 507 and and/or program modules such as operating system 505 and application software 506 that are immediately accessible to and/or are presently operated on by the processing unit 503.

The computer 501 may also include other removable/non-removable, volatile/non-volatile computer storage media. By way of example, FIG. 5 illustrates a mass storage device 504 which can provide non-volatile storage of computer code, computer readable instructions, data structures, program modules, and other data for the computer 501. For example, a mass storage device 504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 504, including by way of example, an operating system 505 and application software 506. Each of the operating system 505 and application software 506 (or some combination thereof) may include elements of the programming and the application software 506. Data 507 can also be stored on the mass storage device 504.

A user can enter commands and information into the computer 501 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 503 via a human machine interface 502 that is coupled to the system bus 513, but may be connected by other interface and bus structures, such as a parallel port, game port, or a universal serial bus (USB).

A display device 511 can also be connected to the system bus 513 via an interface, such as a display adapter 509. For example, a display device can be a monitor or an LCD (Liquid Crystal Display). In addition to the display device 511, other output peripheral devices can include components such as speakers (not shown) and a printer (not shown) which can be connected to the computer 501 via Input/Output Interface 510.

The computer 501 can operate in a networked environment using logical connections to one or more remote computing devices 515a,b,c. By way of example, a remote computing device can be a personal computer, portable computer, a server, a router, a network computer, a peer device or other common network node, and so on. Logical connections between the computer 501 and a remote computing device 515a,b,c can be made via a local area network (LAN) and a general wide area network (WAN). Such network connections can be through a network adapter 508. A network adapter 508 can be implemented in both wired and wireless environments. Such networking environments are commonplace in offices, enterprise-wide computer networks, intranets, and the Internet 208.

For purposes of illustration, application programs and other executable program components such as the operating system 505 are illustrated herein as discrete blocks, although it is recognized that such programs and components reside at various times in different storage components of the computing device 501, and are executed by the data processor(s) of the computer. An implementation of application software 506 may be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

It will be apparent to those skilled in the art that various modifications and variations can be made in the present system and method without departing from the scope or spirit of the system and method. Other embodiments of the system and method will be apparent to those skilled in the art from consideration of the specification and practice of the system and method disclosed herein. It is intended that the specification and examples be considered as exemplary only, with a true scope and spirit of the system and method being indicated by the following claims.

1. A method for sponsoring, comprising:
a. receiving a user selected sponsor target;
b. receiving a monetary amount from the user wherein a portion of the monetary amount is contributed toward a cumulative sponsorship amount;
c. sending the user a sponsorship award;
d. repeating steps a, b, and c until the cumulative sponsorship amount is reached; and
e. sponsoring the user selected sponsor target.

2. The method of claim 1, wherein the user selection is made over a network.

3. The method of claim 1, wherein the user selected sponsor target is selected from the group consisting of:
athletes;
sports teams; and
vehicles.

4. The method of claim 1, wherein the sponsorship award indicates that the user sponsored the user selected sponsor target.

5. The method of claim 1, wherein the value of the sponsorship award is associated with the monetary amount received from the user.

6. The method of claim 1, wherein the sponsor target is selected from the group consisting of:
an Olympic team;
a Nascar® driver; and
an X-Games athlete.

7. A method for sponsoring, comprising:
selecting a sponsor target;
transferring a monetary amount to a host wherein a portion of the monetary amount is contributed toward a cumulative sponsorship amount; and
receiving a sponsorship award.

8. The method of claim 7, wherein the user selection is made over a network.

9. The method of claim 7, wherein the user selected sponsor target is selected from the group consisting of:
athletes;
sports teams; and
vehicles.

10. The method of claim 7, wherein the sponsorship award indicates that the user sponsored the user selected sponsor target.

11. The method of claim 7, wherein the value of the sponsorship award is associated with the monetary amount received from the user.

12. The method of claim 7, wherein the sponsor target is selected from the group consisting of:
an Olympic team;
a Nascar® driver; and
an X-Games athlete.

13. A method of sponsoring, comprising:
listing a sponsor target with a host;
determining a cumulative sponsorship amount;
determining a sponsorship award;
receiving the cumulative sponsorship amount from the host; and
recognizing the host.

14. The method of claim 13, wherein listing is performed over a network.

15. The method of claim 13, wherein the sponsor target is selected from the group consisting of:
athletes;
sports teams; and
vehicles.

16. The method of claim 13, wherein the sponsorship award indicates that a user sponsored the sponsor target.

17. The method of claim 13, wherein the value of the sponsorship award is associated with a monetary amount received from a user.

18. The method of claim 13, wherein the sponsor target is selected from the group consisting of:
an Olympic team;
a Nascar® driver; and
an X-Games athlete.
